(19) United States
(12) Patent Application Publication
(10) Pub. No.: US 2024/0066632 A1
(43) Pub. Date: Feb. 29, 2024

(54) Liquid-Cooled Brake Resistor in the Form of a Plate Heat Exchanger

(71) Applicant: Heine Resistors GmbH, Dresden (DE)

(72) Inventor: Stephan HAAK, Dresden (DE)

(21) Appl. No.: 18/280,102

(22) PCT Filed: Feb. 28, 2022
(86) PCT No.: PCT/EP2022/054961

§ 371 Date: Sep. 1, 2023

(30) Foreign Application Priority Data
Mar. 3, 2021 (DE) 10 2021 202 037.2

(51) Int. Cl. B23K 26/322; B23K 9/23; B23K 26/26

(52) U.S. Cl. CPC B23K 26/322; B23K 9/23; B23K 26/26; B23K 2103/05

(57) ABSTRACT

A shaped metal sheet and a liquid-cooled resistor, which is made up of a plurality of shaped metal sheets, are provided. The shaped metal sheets have a first side which is coated with an electrically insulating layer, an electrically conductive device being applied to the electrically insulating layer or embedded therein, and the shaped metal sheets having a second side through which coolant can flow. By connection of a plurality of shaped metal sheets, a coolable resistor is produced, which is very compact, space-saving and scalable.

### BACKGROUND AND SUMMARY

The present invention relates to a system for transferring heat energy to a liquid medium. This is used for example as liquid-cooled braking resistor.

In the field of drive technology, excess braking energy can be converted in braking resistors—kinetic energy is thus for example converted into electrical energy by a regenerative brake, such as the drive machine in recovery mode, and this electrical energy, if it cannot be used elsewhere, is converted in a cooled braking resistor—the resistor acts as it were as consumer and converts the electrical energy into heat energy, which then correspondingly has to be dissipated in order to avoid local overheating of the braking resistor.

Such a braking resistor must be able to have corresponding tensile strength, sufficient compressive stability (if the medium flowing through has a higher pressure) and power loading in order to be suitable for use.

Braking resistors are used for example in e-trucks (trucks with electric motors) and e-buses but also in the rail vehicle sector, and braking resistors can also be used in other drive concepts, in particular in such drive concepts which have little space and are subject to sound emission limits.

They serve to convert excess electrical energy if it cannot be stored elsewhere—for example when an accumulator that supplies current for the electric motor is fully charged, but the vehicle still needs to be braked via a regenerative brake.

Many air-cooled braking resistors are known from the prior art. However, they require a corresponding ventilation system for cooling and therefore a correspondingly large installation space.

In the prior art, various designs of liquid-cooled braking resistors are also known. For example, an active element, that is to say the actual electrical resistor, can be embedded in an aluminum housing or tubular heating body, in which case the cooling medium has no direct contact with the resistor but is guided through corresponding bores in the aluminum housing, where it takes up heat and thus cools the resistor. Tubular heating bodies can also be used in a closed container, which is correspondingly cooled.

Liquid-cooled braking resistors with a modular structure are also possible, and the actual resistor, that is to say the active element, may be embedded in a flow channel within the housing. The electrical insulation between coolant and active element can be realized for example by a silicone sheath.

In the case of the design in which the active element is insulated in a tubular heating body, the tubular heating body has an insulated and liquid-tight structure. The coolant can then flow around the tubular heating body and correspondingly dissipate heat.

Document EP 2 592 633 A1 discloses a liquid-cooled braking resistor which comprises a block, a liquid inlet, a liquid outlet and a hollow space. The hollow space has an open face which is closed by a thermally conductive but electrically insulating flat layer. This flat layer supports a flat resistor, and the main planes are aligned parallel to one another. The hollow space is provided with a liquid flow path between the liquid inlet and the liquid outlet, and elastic pressing means are accommodated in the hollow space and designed such that the flat layer is pressed against the resistor. The elastic means have a multiplicity of springs which are arranged in the internal liquid flow path of the block. The coolant is guided in meandering fashion along the insulated active element in order to enable sufficient take-up of heat. Such a flow profile, however, causes a significant pressure loss which is intensified even further by the elastic elements.

An object of the invention is therefore to provide a liquid-cooled system for transferring heat energy which has a minimal space requirement and scalability. However, a large heat-transfer surface area, little internal pressure loss, high tensile strength and improved heat transfer efficiency should be realized.

This object is achieved by a shaped metal sheet and a coolable resistor in accordance with the independent claims. The dependent claims relate to further preferred embodiments of the present invention.

A shaped metal sheet according to the invention has the following features:
a first face, which is coated with an electrically insulating layer and an electrically conductive device is applied to or embedded in the electrically insulating layer, and a second face, the latter serving as a surface over which coolant can flow;
an inlet opening and an outlet opening are provided in the shaped metal sheet;
a first bead, which is preferably open at least on one side, is provided on the edge of the first face of the shaped metal sheet;
third beads, which each surround the inlet opening and the outlet opening, are also provided on the first face. All the beads have the same height profile and are planar in relation to one another.

Beads are channel-shaped depressions or stamped indentations which in the present case serve for the sealed joining of two shaped metal sheets.

The electrically insulating layer, which is applied between the shaped metal sheet and the electrically conductive device, ensures that no electrical current flows into the shaped metal sheet. At the same time, the electrically insulating layer has very good heat conductivity in order that the flow of heat generated by the electrically conductive device can be effectively conveyed to the shaped metal sheet and, from the second face of the latter, to the coolant by convection. Preferably, the electrically insulating layer is made of ceramic, sintered ceramic paste or a ceramic composite material and can be applied by thermally spraying ceramic, or sintering ceramic pastes or similar insulating materials. The materials used have material properties such that thermal stresses do not lead to the formation of cracks.

The layer thickness is applied in dimensions depending on the insulation requirement and has very low heat transmission resistance, which in particular can be obtained by ceramic composite materials.

The layer thickness of the electrically insulating layer is preferably 50-500 μm.

The heat conductivity of the material of the electrically insulating layer is preferably between 0.5 and 2 W/mK, more preferably is 1 W/mK.

The electrically conductive device preferably has a conductor applied by a screen printing process.

The shaped metal sheet, which is in the form of a plate with a stamped contour, combines the heat source (electrically conductive device) on the first face and the heat sink (surface over which coolant can flow) on the second face. The compact structure enables a large heat-transfer surface area together with a small heat conducting section which ensures the optimum dissipation of heat to the coolant and thus increases the heat transfer coefficient.

The shaped metal sheet is preferably rectangular and therefore easy to manufacture.

Preferably, the first bead protrudes from the first face of the shaped metal sheet, more preferably obliquely (that is to say forms an acute angle with the normal vector of the first face of the shaped metal sheet). This facilitates the possibility for joining to further shaped metal sheets with the same structure—if first faces of two shaped metal sheets face one another, two first beads also face one another and can therefore be joined to one another easily—and this also produces a sufficiently large cavity between two first faces of two shaped metal sheets, as a result of which there is enough space for two spaced-apart electrically conductive devices—one on the first face of each shaped metal sheet.

Preferably, a second bead, which more preferably surrounds the shaped metal sheet, is provided on the edge of the second face of the shaped metal sheet that serves as surface over which coolant can flow. The second bead serves for joining to a second face of a further shaped metal sheet.

More preferably, at least one fourth bead, which subdivides the second face of the shaped metal sheet and thus enables a U-shaped flow path, is provided. If the two faces of two shaped metal sheets face one another and the two fourth beads are joined to one another, the fourth beads can be used to define a flow path for the coolant that is as long as possible.

Preferably, the shaped metal sheet is made from stainless steel. This material is corrosion-resistant, has good heat conductivity and can be machined easily.

Preferably, at least two contact-connection surfaces, which are joined electrically conductively to a respective end of the electrically conductive device, are provided on the first face of the shaped metal sheet. A connection element can be connected to each of these contact-connection faces.

More preferably, a clearance (a type of recess or depression), which adjoins the at least two contact-connection surfaces, is provided on an edge of the first face of the shaped metal sheet. This clearance is configured such that it makes enough space available to provide a connection element (for electrical connections) or other joining elements.

A coolable electrical resistor according to the invention comprises at least two shaped metal sheets according to the invention—this is, as it were, the smallest unit of a coolable resistor. The combination of exactly two shaped metal sheets to form a coolable electrical resistor is also referred to as pair of shaped metal sheets below.

The respective first faces of two shaped metal sheets face one another. In the case of a rectangular shape, the two shaped metal sheets are joined to one another at the respective first beads (which are then preferably arranged on three peripheral faces of the shaped metal sheets) and third beads.

The joining of the respective first beads produces a cavity between the two first faces of the two shaped metal sheets, and the two shaped metal sheets are fixedly and sealingly joined to one another at least on three sides at the edge (if the shaped metal sheets are rectangular). The third beads, which each surround the inlet opening and outlet opening of the shaped metal sheets, are also likewise joined to one another. This means that no cavity is present in the region of the inlet openings and outlet openings, but rather that there is a common inlet opening and outlet opening and no liquid can enter the cavity through them.

Furthermore, the hollow space, that is to say the cavity between the respective first faces of two shaped metal sheets, is more preferably at least partially filled with a filler, wherein the filler even more preferably contains silicone. Filling the cavity with a filler, especially silicone, serves to ensure compressive stability and a homogeneous temperature distribution.

It is therefore also possible to seal off a face on which there is no first bead on the shaped metal sheets.

Preferably, respective second faces of two shaped metal sheets also face one another, and the two shaped metal sheets are joined to one another by the respective second beads. This produces a cavity between the respective second faces of two shaped metal sheets in this case, too, wherein the edges are sealed off by the joining of the respective second beads. The cavity between the respective second faces of two shaped metal sheets serves for coolant to flow through.

More preferably, the fourth beads are also joined to one another, and therefore a flow path which is designed for a coolant to be able to flow from the inlet opening to the outlet opening is defined between the respective second faces of the two shaped metal sheets. A U-shaped flow path is generally preferred in this respect and is also required in the preferred embodiment described here in order that there is no direct link between the inlet and outlet openings.

However, the position of the inlet opening and outlet opening can in principle be selected as desired.

The fourth bead serves only to guide the flow in the case of inlet and outlet openings which are next to one another. In the case of mutually facing openings, the fourth bead would not be necessary or would contribute at most to homogenizing the flow.

A pair of shaped metal sheets of a coolable resistor according to the invention thus comprises two shaped metal sheets, an insulating means and an electrically conductive device, which is between two shaped metal sheets, for each shaped metal sheet and two electrical connection elements, which join the electrically conductive devices electrically in parallel. In this case, the two shaped metal sheets, preferably of identical design, are combined with one another such that the first faces, that is to say the resistor faces, are aligned toward one another and form a cavity.

In applications with a higher insulation requirement, the electrical conductor can also be introduced as thin metal plate which has a meandering shape and is inserted into the cavity of the pair of shaped metal sheets through an insulating encapsulation, especially comprising silicone.

The outer faces of the pair of shaped metal sheets, that is to say the respective second faces of the shaped metal sheets, constitute the heat sink and are designed such that a further cavity is produced when at least two shaped metal sheets are arranged in series. The cavity is formed such that the coolant flows past the second faces of the shaped metal sheets with a high flow velocity and generates a high degree of turbulence, which ensures the dissipation of heat to the coolant.

The structure of pairs of shaped metal sheets which have electrically conductive devices in the inner cavity and around which, on the second faces of the shaped metal sheets forming the pair of shaped metal sheets (that is to say on both sides), coolant flows, ensures a large heat-transfer surface area together with high compressive stability.

It is precisely the small spacing between the second faces of two shaped metal sheets (or one shaped metal sheet and an edge of a flow space) that leads to sufficiently high flow velocities, which ensure a sufficiently high degree of turbulence for the transfer of heat from the shaped metal sheet or pair of shaped metal sheets to the coolant.

This makes it possible to have the effect of enabling a good transfer of heat to the coolant with a very compact structure. The volume and weight of a coolable resistor are significantly reduced in relation to those of the liquid-cooled braking resistors currently on the market.

Furthermore, the simple structure and the use of identical parts provides very small variety of parts, leading to a reduction in costs.

The scaling of the number of pairs of shaped metal sheets enables easy scaling of the power class and enables a modular structure, depending on the power requirement.

Preferably, the first, second, third and/or fourth beads of two shaped metal sheets are joined to one another by a join, preferably a laser weld seam. Such joining processes can be realized easily and are cost-effective. Crimping or resistance welding with rollers is also possible.

More preferably, any desired number of shaped metal sheets (two shaped metal sheets form a respective pair of shaped metal sheets here) are joined to one another, even more preferably are arranged in parallel. The pairs of shaped metal sheets can thus be stacked.

Preferably, a respective end plate is provided as outer boundary, wherein a second face of the top shaped metal sheet is joined to a first end plate and with it forms a flow channel, and wherein a second face of the bottom shaped metal sheet is joined to a second end plate and with it likewise forms a flow channel.

This enables a modular arrangement of the pairs of shaped metal sheets with a structure which is as compact as possible, and no further housing is necessary to maintain the degree of protection, either. The systemic pressure can be taken up by the end plates, as a result of which the inner pairs of shaped metal sheets (their shaped metal sheets preferably being thinner than the end plates) have compressive stability.

The force vectors of the coolant pressure are thus eliminated and no further outward tensions are generated as a result.

Preferably, an inlet port and/or an outlet port are/is provided either on the first end plate or on the second end plate. However, it is also possible for one of the two ports to be provided on the first end plate and the other port to be provided on the second end plate. However, inlet ports and/or outlet ports could also be arranged as desired if the shaped metal sheet satisfies the condition of axial symmetry and the inlet ports and/or outlet ports are parallel to the normal vector of the face of the shaped metal sheet.

The inlet port is fluidically connected to all the inlet openings of all the pairs of shaped metal sheets and thus also the shaped metal sheets, and the outlet port is fluidically connected to all the outlet openings of all the pairs of shaped metal sheets and thus also the shaped metal sheets.

Since all the pairs of shaped metal sheets have inlet openings and outlet openings, internal collection regions which distribute fluid or indeed collect it form here. Fluid can thus flow around all the pairs of shaped metal sheets.

In the process, the guidance of the flow between the stacks leads from the internal collection regions to the individual interspaces between pairs of shaped metal sheets, where one or more deflection means guide the flow to the facing collection region.

In particular, the simple deflection gives a low internal pressure loss. Therefore, the structure of a parallel connection of the coolant flow, proceeding from a collection region, with as far as possible only one deflection, enables a low pressure loss.

Preferably, respective contact-connection surfaces of two opposite first faces of two shaped metal sheets in a coolable resistor are each joined by means of a connection element, which preferably protrudes beyond the shaped metal sheet or the pair of shaped metal sheets.

Preferably, connection elements are arranged on the face opposite the inlet opening and outlet opening—for example, the inlet opening and outlet opening are arranged on a short side of a rectangle, and the connection elements are arranged on the other short side.

Preferably, for a system of multiple coolable resistors, an electrical interface, for example a plug with at least one contact element, is also provided—it is, however, necessary for there to be as many contact elements as there are connection elements—generally two for each coolable resistor (positive pole and negative pole—in the case of phase current, however, it is also possible to provide more than two connection elements). The position of the connection elements can be varied such that, in the constructed state, the connection of a multi-phase system is enabled, and in this case the connection elements depending on the phase are not directly one above another.

The connection elements are designed to each be joined to a contact element of the electrical interface or of the plug, wherein a contact element more preferably comprises resilient clips. The clips ensure that secure contact can be established with the connection elements and also it is easy to mount the plug (which indeed may contain many contact elements). Therefore, available current can be easily distributed among a system of coolable resistors.

A preferred embodiment of the present invention will be described in more detail below with reference to the appended figures.

### BRIEF DESCRIPTION OF THE DRAWINGS

FIG. 1 shows a first face of a shaped metal sheet with printed insulating means and an electrically conductive device.

FIG. 2 shows a shaped metal sheet with the second face (coolant face) upward.

FIG. 3a shows a plan view of a coolable resistor (pair of shaped metal sheets) according to the invention which is composed of two shaped metal sheets, according to one embodiment of the present invention.

FIG. 3b shows three detailed cross-sectional views of the coolable resistor according to the invention.

FIG. 4 shows an isometric view, in partial section, of a coolable resistor according to the invention.

FIG. 5 shows a plan view of a coolable resistor (system of multiple pairs of shaped metal sheets).

FIG. 6 shows a sectional view of the system, showing the detail of the entrance of the flow (on the left) and the electrical connection (on the right).

FIG. 7 shows an isometric view of a coolable resistor (system of multiple pairs of shaped metal sheets).

### DETAILED DESCRIPTION OF THE DRAWINGS

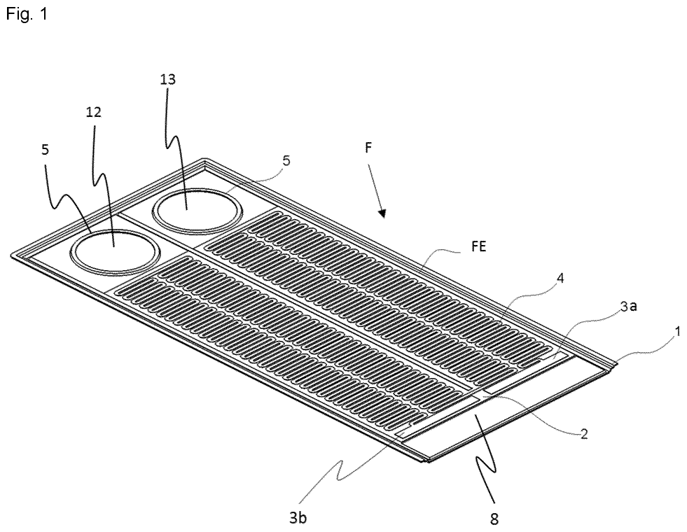

FIG. 1 illustrates an isometric illustration of a first face FE, the resistor face, of a shaped metal sheet F.

The shaped metal sheet F is surrounded on three sides by a first bead 1, which protrudes obliquely upward from the shaped metal sheet F. Beads are channel-shaped depressions or elevations of a metal sheet. Two openings 12, 13, here an outlet opening 12 and an inlet opening 13, are provided in the shaped metal sheet F. The openings are each surrounded by a third bead 5, which each likewise protrude upward from the shaped metal sheet F. The first bead 1 and the third beads 5 are designed such that they form a plane and produce a cavity in conjunction with a further shaped metal sheet and its corresponding first and third beads (not illustrated here).

An electrically insulating layer 2 is arranged in the inner region of the first face FE of the shaped metal sheet F. The electrically conductive device 4 is arranged in meandering fashion thereon. Two contact-connection surfaces 3a, 3b are also provided, each of which is joined to an end of the electrically conductive device 4. A clearance 8 in the form of a depression is provided at that end of the shaped metal sheet F which faces away from the outlet opening 12 and the inlet opening 13 and on which no first bead 1 is provided. Connection elements (not illustrated here) can be arranged in this clearance.

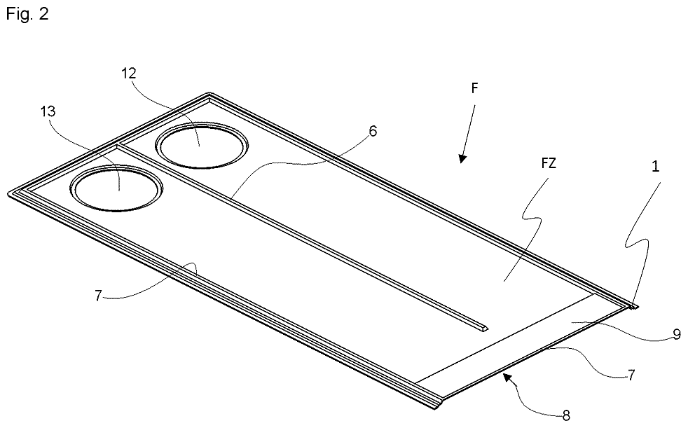

FIG. 2 illustrates an isometric illustration of a second face FZ of the shaped metal sheet, the coolant face.

Second beads 7 protrude upward on four sides of the shaped metal sheet F on the second face FZ and therefore extend in the opposite direction to the first bead 1. A fifth bead 9, which is wider than the second beads 7, is provided on a short face of the shaped metal sheet F—this is the back side of the clearance 8 on the first face FE. Also arranged parallel to the first bead in the center between the two long faces FZ of the shaped metal sheet F is a fourth bead 6, which however does not extend over the entire length of the shaped metal sheet F. The second bead 7 and the fourth bead 6 are the same height and therefore form a plane. The fifth bead 9 is slightly recessed in order to ensure a cavity for cooling the connection region. The second beads 7 form a peripheral contour which closes a cavity upon arrangement of a further shaped metal sheet (not shown here) and thus defines the coolant region. The fourth bead 6 serves to guide the flow between the inlet and outlet 13, 12.

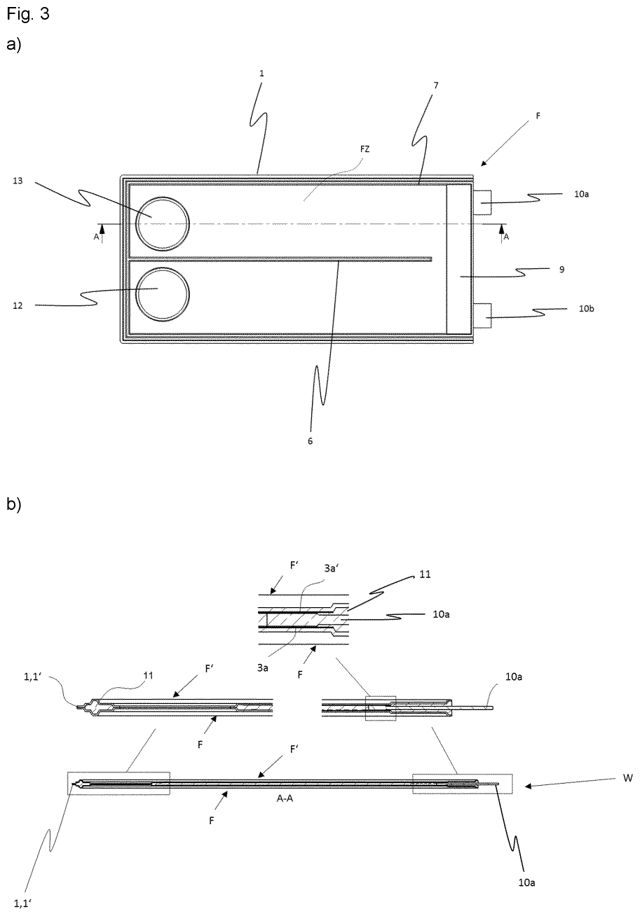

FIG. 3a illustrates a plan view of a coolable resistor W according to the invention, consisting of two shaped metal sheets F, F′ (also referred to below as pair of shaped metal sheets)—this is looking at the second face FZ of the one shaped metal sheet F (the further shaped metal sheet F′ joined to the shaped metal sheet F cannot be seen here). The first beads 1, 1′ of the shaped metal sheets F, F′ are joined by an integral bonding process, for example lasering, adhesive bonding, resistance welding or the like, such that a cavity is produced (not visible in this figure). The second bead 7 (for joining to further pairs of shaped metal sheets and for delimiting the coolant) is also visible in turn on the top side of the second face FZ of the shaped metal sheet F. The fourth bead 6 serves to guide the flow between the inlet and outlet 13, 12. The fifth bead 9 can be seen on the right-hand edge of the shaped metal sheet F. The second bead 7 serves for joining to a second face of a further shaped metal sheet F″ (not illustrated here). A first and a second connection element 10a, 10b, which are preferably made from copper or another readily conductive material, protrude beyond the coolable resistor W, here on that face of the shaped metal sheet F that faces away from the inlet 13 and outlet 12.

FIG. 3b shows detailed cross-sectional views of the coolable resistor W according to the invention from FIG. 3a.

The bottom view in this figure constitutes a cross section A-A (position shown in FIG. 3a). It is clear from this that two shaped metal sheets F, F′ are joined to one another at their respective first beads 1, 1′. A first connection element 10a protrudes beyond the coolable resistor W at the right-hand end.

The center view, which shows details relating to the left-hand and the right-hand end of the coolable resistor W, depicts that the edge regions of the coolable resistor W are filled with a filler 11, in this case silicone. The silicone additionally seals off the inner space of the coolable resistor W.

The top view shows more details of the right-hand edge region. Here, it can be seen that two first contact-connection surfaces 3a, 3a′, which are respectively arranged on the internal face of two shaped metal sheets F, F′, are both joined electrically conductively to the first connection element 10a—in turn, the corresponding hollow space between the two shaped metal sheets F, F′ is filled with a filler 11.

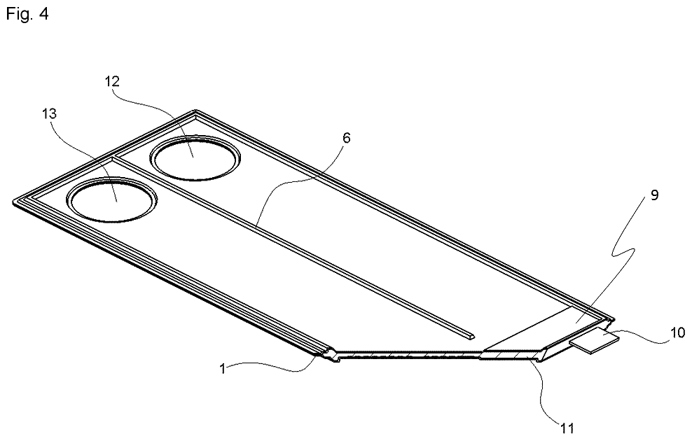

FIG. 4 illustrates an isometric view, in partial section, of the coolable resistor W. What is shown here is that two shaped metal sheets F, F′ are joined, among other things via the respective first beads 1, 1′ and third beads 5, 5′ (not shown here)—by virtue of the join between two respective third beads 5, 5′ of the two shaped metal sheets F, F′, a common inlet 13 and outlet 12 are formed, without liquid being able to enter the inner space of the coolable resistor W here. The third beads 5, 5′ thus serve to close the pair of shaped metal sheets in the region of the coolant guide.

This enables a design in the form of a pair of shaped metal sheets with one shaped metal sheet being in the form of a resistor support and one shaped metal sheet being designed for coolant separation. The two shaped metal sheets F, F′ form a coolable electrical resistor W here.

The second face of the shaped metal sheet F′ is shown from above, that is to say the face along which coolant is to flow—it flows from the inlet 13 to the outlet 12 and is deflected at the edge by the second bead 7 and the fourth bead 6, which serves to guide the flow.

It is also clear that the two shaped metal sheets F, F′ enclose an inner hollow space—which is filled with a filler 11 at the right-hand edge—the first connection element 10a is embedded in this filler and is also correspondingly insulated with respect to the two shaped metal sheets F, F′ by the filler.

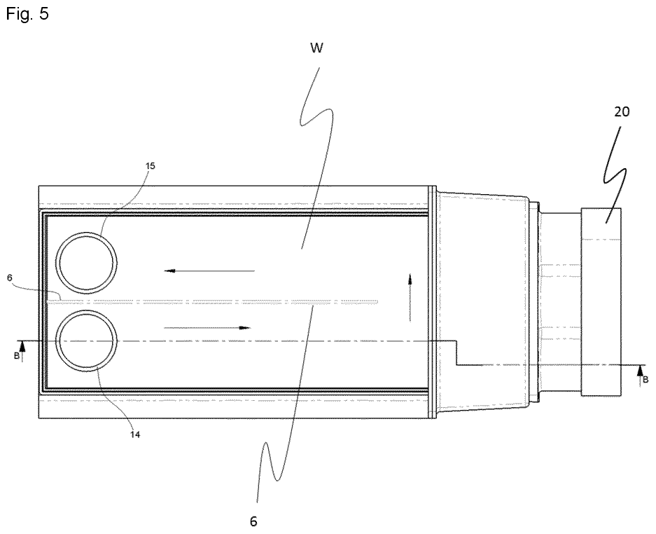

FIG. 5 illustrates a plan view of multiple pairs of shaped metal sheets W (here only the top one is visible). The inlet port 14 and the outlet port 15, which are attached to the inlet 13 and outlet 12 (not shown here), are illustrated. A dashed line indicates the fourth bead 6, which is however inside the first pair of shaped metal sheets. Arrows outline the flow direction of the coolant inside the top coolable resistor W. The coolant flows inside all coolable resistors, which are arranged one above another, from the inlet port 14 to the outlet port 15 and is distributed among the coolable resistors according to the number of coolable resistors arranged one above another. A plug 20 which serves for electrical connection is arranged on the right-hand edge.

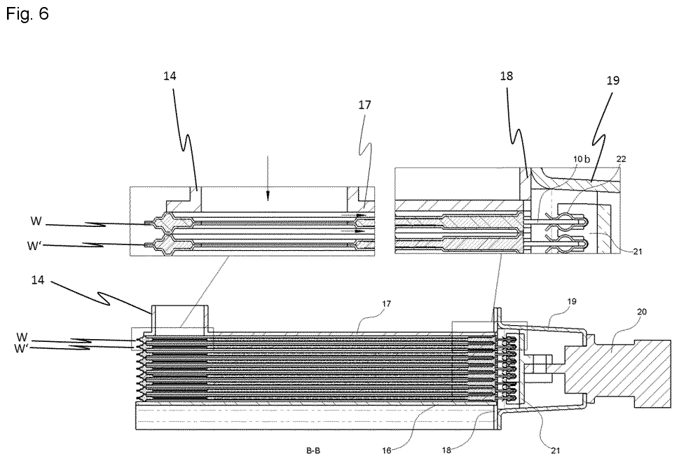

FIG. 6 illustrates the sectional view through an exemplary system along the line B-B in FIG. 5, wherein coolable electrical resistors (pairs of shaped metal sheets) W, W′, . . . connected hydraulically in parallel and a corresponding electrical connection are illustrated.

The bottom view illustrates an overall sectional view.

The inlet port 14 is mounted on an upper end plate 17.

In this case, the coolant travels to the individual coolable electrical resistors W, W′, . . . via the inlet port 14 and is distributed in parallel into the interspaces, where it exits again at the outlet port 15 (not shown here) after being deflected.

The inlet opening 13 and outlet opening 12 (not illustrated here) of the individual coolable resistors W, W′ . . . form internal collectors, as it were, which are then fluidically connected to the inlet port 14 and the outlet port 15. This makes it possible to connect the individual coolable resistors W, W′, . . . hydraulically in parallel. A few deflection means make it possible to realize a low internal pressure loss.

A lower end plate 16 and the upper end plate 17 are arranged at the respective start and end of the coolable electrical resistors W, W′, . . . , that is to say pairs of shaped metal sheets, arranged in series. The lower end plate 16 and the upper end plate 17 are rigid enough to withstand the systemic compressive loading. The lower end plate 16 can serve to fasten the overall system and, alongside the upper end plate 17, forms the means for fastening the front plate 18 to the right-hand edge, to which a protective cover 19 is fastened. The plug 20, which comprises contact elements 21, is fastened in the protective cover 19.

The upper right view of a detail illustrates that a contact element 21 is formed such that it can accommodate resilient clips 22 of electrically readily conductive material. A round cutout and a transverse arresting means, for example by virtue of a tongue-and-groove combination (not illustrated here), prevent the clips 22 from becoming detached. The clips 22 are slightly undersized and expand slightly when the contact elements 10b are pushed in. The internal loading on the contact element 21, in the region of the clips 22 is very low and requires a reinforced arrangement of material only at the edge.

The upper left view of a detail indicates how coolant enters through the inlet port 14 and flows respectively between the top coolable resistor W and the upper end plate 17 and between the top coolable resistor W, W′ and the next one down.

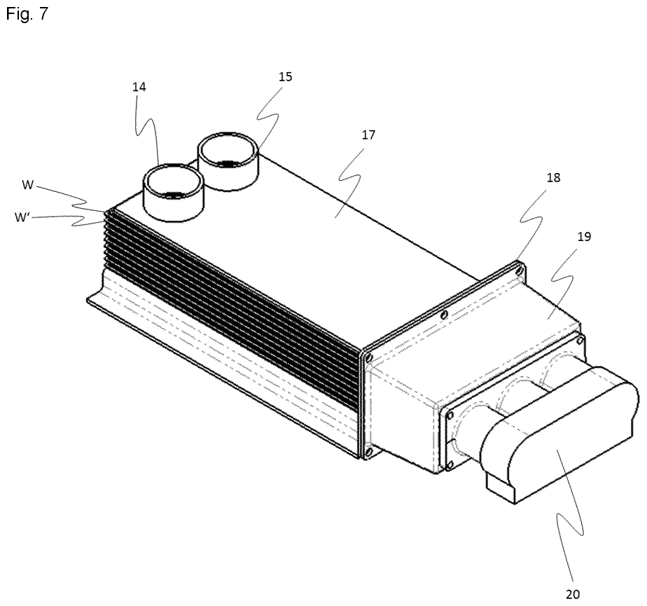

In FIG. 7, the overall system is arranged in an isometric illustration and the compact design of a braking resistor with integrated connector plug 20 is depicted.

Multiple coolable resistors W, W′, . . . are arranged underneath the upper end plate 17. The inlet port 14 and the outlet port 15 for the coolant are also arranged on the upper end plate 17. Optical sensors (not shown here) for monitoring the coolant temperature can be mounted on the connection ports. The front plate 18 is mounted on the end face and covered by the protective cover 19. The plug 20 can be mounted on the protective cover 19.

The present invention is not restricted to the embodiment described above. For example, the inlet and outlet ports 14 and 15 may take different geometric shapes, as may the inlet 13 and outlet 12. The coolable resistors W, or shaped metal sheets F, are preferably rectangular but may also take different geometric shapes, such as round, oval, polygonal—depending on the available space.

The present invention relates to a shaped metal sheet F and to a liquid-cooled resistor formed from multiple shaped metal sheets F, F′, . . . , F″.

The shaped metal sheets F have a first face FE, which is coated with an electrically insulating layer 2, wherein an electrically conductive device 4 is applied to or embedded in the electrically insulating layer 2, and a second face FZ, along which coolant can flow.

Joining multiple shaped metal sheets F, F′, . . . , F″ results in a coolable resistor which is very compact, saves on space and can be scaled.

### LIST OF REFERENCE SIGNS

F Shaped metal sheet
FE First side
FZ Second side
W Coolable resistor/pair of shaped metal sheets
1 First bead
2 Electrically insulating layer
3a First contact-connection surface
3b Second contact-connection surface
4 Electrically conductive device
Third bead
6 Fourth bead
7 Second bead
8 Clearance
9 Fifth bead
10a First connection element
10b Second connection element
11 Filler
12 Outlet
13 Inlet
14 Inlet port
Outlet port
16 Lower end plate
17 Upper end plate
18 Front plate
19 Protective cover
Electrical interface/plug
21 Contact element/copper
22 Resilient clip

1.-11. (canceled)

12. A shaped metal sheet, comprising:
a first face coated with an electrically insulating layer, wherein an electrically conductive device is applied to or embedded in the electrically insulating layer;
a second face;
an inlet opening and an outlet opening provided in the shaped metal sheet;
a first bead provided on an edge of the first face, and
third beads respectively surrounding the inlet opening and the outlet opening on the first face.

13. The shaped metal sheet as claimed in claim 12, wherein one or more of:
the first bead protrudes from the first face,
a second bead is provided on an edge of the second face,
at least one fourth bead is provided on the second face, or
the shaped metal sheet is made from stainless steel.

14. The shaped metal sheet as claimed in claim 13, wherein the first bead protrudes obliquely from the first face.

15. The shaped metal sheet as claimed in claim 12, wherein
at least two contact-connection surfaces, which are electrically conductively joined to a respective end of the electrically conductive device, are provided on the first face,
a clearance, which adjoins the at least two contact-connection surfaces, is further provided on an edge of the first face.

16. A coolable resistor, comprising:
two shaped metal sheets, each sheet comprising:
a first face coated with an electrically insulating layer, wherein an electrically conductive device is applied to or embedded in the electrically insulating layer;
a second face;
an inlet opening and an outlet opening provided in the shaped metal sheet;
a first bead provided on an edge of the first face, and
third beads respectively surrounding the inlet opening and the outlet opening on the first face;
wherein respective first faces of the two shaped metal sheets are arranged facing one another, and
the two shaped metal sheets are joined to one another at the respective first beads and third beads.

17. The coolable resistor as claimed in claim 16, wherein
a hollow space between respective first faces of the two shaped metal sheets is at least partially filled with a non-conductive filler.

18. The coolable resistor as claimed in claim 17, wherein the filler contains silicone.

19. The coolable resistor as claimed in claim 16, wherein
respective second faces of the two shaped metal sheets are arranged facing one another and the two shaped metal sheets are joined to one another at respective second beads formed on respective edges of the respective second faces,
fourth beads, provided on the respective second faces, are joined to one another, and a flow path is therefor defined between the respective second faces of the two shaped metal sheets, which flow path is designed such that a fluid can flow from the inlet opening to the outlet opening.

20. The coolable resistor as claimed in claim 19, wherein the first, third and/or fourth beads of the two shaped metal sheets are joined to one another by a laser weld seam.

21. The coolable resistor as claimed in claim 16,
wherein any desired number of shaped metal sheets, or pairs of shaped metal sheets are joined to one another,
wherein a respective end plate is provided as an outer boundary,
wherein a second face of the first shaped metal sheet is joined to a first end plate and together form a flow channel, and wherein a second face of a last pair of shaped metal sheets is joined to a second end plate and together form a flow channel,
wherein any desired number of shaped metal sheets are arranged in parallel.

22. The coolable resistor as claimed in claim 21, wherein
an inlet port and an outlet port are provided either on the first end plate or on the second end plate, and
the inlet port is fluidically connected to all the inlet openings of all the shaped metal sheets, and
the outlet port is fluidically connected to all the outlet openings of all the shaped metal sheets, or pairs of shaped metal sheets.

23. The coolable resistor as claimed in claim 16, wherein the at least two shaped metal sheets of the coolable resistor are configured with at least two contact-connection surfaces, which are electrically conductively joined to a respective end of the electrically conductive device, on the first face,
a clearance, which adjoins the at least two contact-connection surfaces, is further provided on an edge of the first face,
wherein the respective contact-connection surfaces of two facing first faces of two shaped metal sheets are each joined to a connection element which protrudes beyond the shaped metal sheets.

24. The coolable resistor as claimed in claim 23, further comprising:
an electrical interface with at least one contact element,
wherein the connection elements are designed to each be joined to a contact element,
wherein a contact element comprises resilient clips.
